(19) United States
(12) Patent Application Publication
(10) Pub. No.: US 2010/0034520 A1
(43) Pub. Date: Feb. 11, 2010

(54) APPARATUS AND METHOD FOR ANALYZING PICTURES FOR VIDEO COMPRESSION WITH CONTENT-ADAPTIVE RESOLUTION

(75) Inventor: Chul CHUNG, Seoul (KR)

Correspondence Address: H.C. PARK & ASSOCIATES, PLC, 8500 LEESBURG PIKE, SUITE 7500, VIENNA, VA, 22182, US

(73) Assignee: Mondo Systems Co., Ltd., Seoul (KR)

(21) Appl. No.: 12/536,039

(22) Filed: Aug. 5, 2009

(30) Foreign Application Priority Data
Aug. 5, 2008 (KR) 10-2008-0076429

(51) Int. Cl. H04N 7/26; H04N 17/00

(52) U.S. Cl. 386/109; 348/180; 348/E17.001; 386/E05.001

(57) ABSTRACT

An apparatus and method for compressing a video in a video processing system include an adaptive video analyzing apparatus and method for compressing a video after determining a resolution per each frame or group of frames of the video. The adaptive video analyzing apparatus may include an analyzing part to determine the resolution in accordance with a pre-determined standard, and a compressing part to compress the video based on the determined resolution.

### CROSS REFERENCE TO RELATED APPLICATION

This application claims priority from and the benefit of Korean Patent Application No. 10-2008-0076429, filed on Aug. 5, 2008, which is hereby incorporated by reference for all purposes as if fully set forth herein.

### BACKGROUND OF THE INVENTION

1. Field of the Invention

Exemplary embodiments of the present invention relate to an apparatus and method for compressing a video in a video processing system. In particular, exemplary embodiments of the present invention relate to an adaptive video analyzing apparatus and method for compressing a video based on a resolution per frame or group of frames of the video.

2. Discussion of the Background

The bit rate to encode moving pictures (i.e., video) is determined by various parameters, including, for example, a resolution of the moving picture. Current methods employed to transmit moving pictures having different resolutions include broadcasting by mixing standard-definition (SD) and high-definition (HD) clips using a Moving Pictures Expert Group (MPEG) 2 system, and by changing the resolution of each sequence using a H.264 compression standard. However, existing methods only focus on transmission after mixing, encoding and decoding the video clips encoded with various resolutions, and do not focus on improving the transmission bit rate.

### SUMMARY OF THE INVENTION

Exemplary embodiments of the present invention provide an adaptive video analyzing apparatus and method for efficiently decreasing a bit rate of a broadcast video in a video processing system. In particular, exemplary embodiments of the present invention provide an adaptive video analyzing apparatus and method for determining a resolution per frame and/or scene of a video.

Additional features of the invention will be set forth in the description which follows, and in part will be apparent from the description, or may be learned by practice of the invention.

Exemplary embodiments of the present invention disclose a video processing system comprising an analyzing part and a compressing part. The analyzing part receives a video, analyzes the video per frame or scene, and determines a resolution of the frame or scene. The compressing part compresses the video based on the resolution.

Exemplary embodiments of the present invention disclose a method to analyze a video. The method comprises receiving an input video, analyzing the input video per frame or scene, determining a resolution of the input video, and compressing the input video based on the resolution.

Exemplary embodiments of the present invention disclose a video processing system having a saving and recording media. The saving and recording media is configured to analyze an input video per frame or scene, determine a resolution of the input video, and compress the input video based on the resolution.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a video analyzing apparatus according to exemplary embodiments of the present invention.

FIG. 2 is a block drawing illustrating the analyzing part of the video analyzing apparatus according to exemplary embodiments of the present invention.

FIG. 3 is a flow chart illustrating a video analyzing method according to exemplary embodiments of the present invention.

FIG. 4 is a flow chart illustrating a video analyzing method according to exemplary embodiments of the present invention.

FIG. 5 is a flow chart illustrating a video analyzing method according to exemplary embodiments of the present invention.

FIG. 6 and FIG. 7 illustrate examples of a mapping chart according to exemplary embodiments of the present invention.

### DETAILED DESCRIPTION OF THE ILLUSTRATED EMBODIMENTS

The present invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Exemplary embodiments of the invention relate to a video analyzing apparatus and a method for analyzing and compressing a video in a video processing system.

In the following description, exemplary embodiments of the present invention are described in detail with reference to the accompanying drawings.

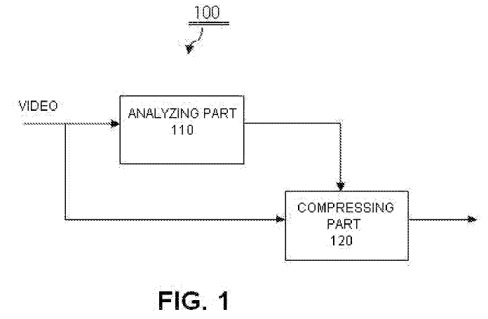

A video processing system may have a video analyzing apparatus and/or may be implemented using a saving and recording media. FIG. 1 is a block diagram illustrating a video analyzing device 100 according to exemplary embodiments of the present invention.

Referring to FIG. 1, the video analyzing apparatus 100 may include an analyzing part 110 to determine a resolution of an input video, and a compressing part 120 to compress portions of the input video based on the determined resolution.

A video may be input to the video analyzing apparatus 100 and may be referred to as the input video hereinafter. The analyzing part 110 may determine a resolution of each frame of the input video and/or a resolution of a scene. In general, a scene may refer to a group of two or more frames of the input video. In some cases, frames belonging to the same scene (e.g., continuing scene) may have the same or similar resolution. A method, MAD, may be used to determine the resolution of each scene/frame, and may allocate the same resolution to all frames within the scene. In some cases, it may be more efficient to determine the resolution per scene instead of per frame because multiple frames in a video may have been compressed using compression techniques such as, for example, MPEG and H.264, and may have the same frame structure. In general, any suitable video resolution determination method may be used.

The compressing part 120 may compress the input video according to the resolution determined per frame or scene by the analyzing part 110. The compression part 120 may use any suitable compression method that changes the determined resolution per frame or scene of the input video. For example, compressing part 120 may change the resolution per frame or scene within a video using H.264.

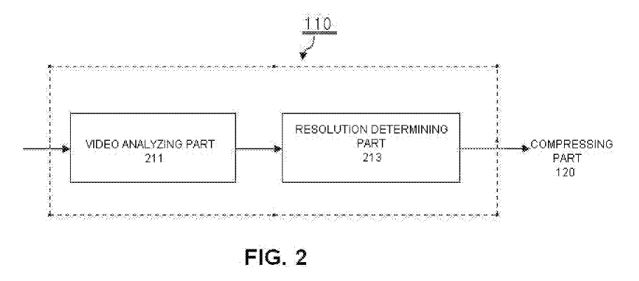

FIG. 2 is a block drawing illustrating the analyzing part 110 of the video analyzing device 100 according to exemplary embodiments of the present invention. As shown in FIG. 2, the analyzing part 110 may include a video analyzing part 211 and a resolution determining part 213.

As noted above, the analyzing part 110 may determine the resolution per frame and/or scene of the input video. Various methods can be used to determine the resolution. By way of example and referring to FIG. 2, the following two methods may be used to determine the resolution per frame and/or scene of the input video.

The first method to determine the resolution may be based on an estimated distance between a camera capturing the input video feed and a subject of the camera. For example, if the estimated distance between the camera and the subject is relatively small, the resolution of the frame and/or scene may be determined to be low. If the estimated distance between the camera and the subject is large, the resolution may be determined to be high. As an example, a low resolution may roughly correspond to 720×480 pixels of SD class resolution, and a higher resolution may roughly correspond to 1920×1080 or 1280×720 pixels of HD class resolution.

The video analyzing part 211 may estimate the distance between the camera and the subject through any suitable video analysis. Examples of known methods to estimate the distance between the camera and the subject can be found in some of the following references. It should be appreciated that methods for estimating distance are not confined to those published in the following references, and that other suitable methods for estimating distance can be used.

Reference 1: (A. Torralba, A. Oliva, “Depth estimation from image structure,” IEEE Transactions on Pattern Analysis and Machine Intelligence, Volume 24, Issue 9, September 2002, pages: 1226-1238); Reference 2: (Shang-Hong Lai, Chang-Wu Fu, and Shyang Chang, “A generalized depth estimation algorithm with a single image,” IEEE Transactions on Pattern Analysis and Machine Intelligence, Volume 14, Issue 4, April 1992, pages: 405-411; and Reference 3: (C. Simon, F. Bicking, and T. Simon, “Depth estimation based on thick oriented edges in images,” 2004 IEEE International Symposium on Industrial Electronics, Volume 1, Issue: 4-7 May 2004, pages: 135-140 vol. 1).

The resolution determining part 213 may determine the resolution using the estimated distance and a mapping chart. In some cases, the estimated distance may be an average of estimated distances determined by the video analyzing part 211.

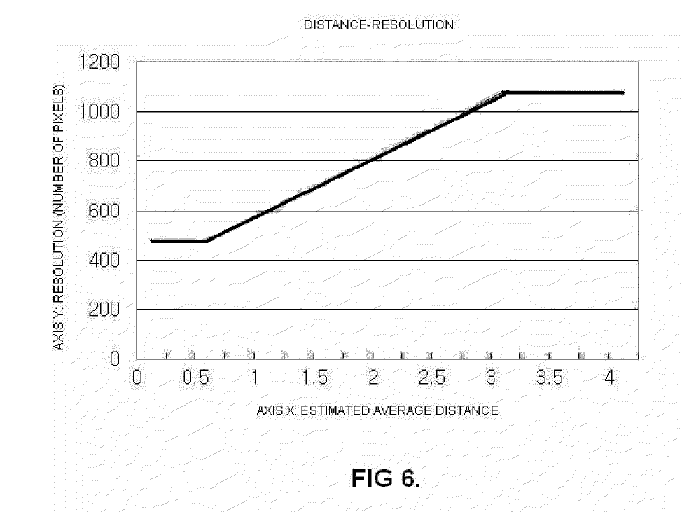

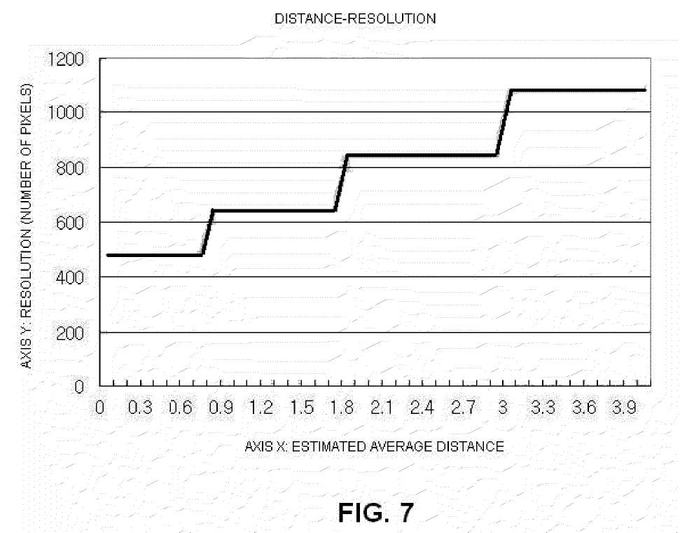

FIG. 6 and FIG. 7 provide examples of mapping charts that provide a relationship between the resolution and the estimated distance between the camera and the subject. FIG. 6 and FIG. 7 illustrate two exemplary embodiments of how mapping between the estimated distance and resolution may be achieved. It should be understood that other suitable mapping methods may be used. For example, mapping methods that may map a relatively short distance closer to a SD resolution and a relatively long distance closer to a HD resolution may be used. In general, a threshold may be used to determine how long or short a distance may be. For example, a distance greater than the threshold could be considered to be a long distance and a distance less than the threshold could be considered to be a short distance. It should be understood that the numbers and dimensions provided in FIG. 6 and FIG. 7 are for illustrative purposes only and are not limited thereby.

As shown in FIG. 6 and FIG. 7, the mapping charts may provide a resolution based on a corresponding estimated distance, which may be an average estimated distance between the camera and the subject as described above. Methods to calculate the estimated average distance have been published extensively and shall not be detailed herein. The methods for calculating the estimated average distance are not limited to prior published work and, in general, any suitable method to calculate the estimated average distance may be used.

The second method to determine the resolution of a frame and/or scene is to determine a thickness of a thickest and strongest edge in a frame or scene of a video. The resolution may be derived from the thickness of the thickest and strongest edge because human eyes are sensitive to the thickest and strongest edge.

The video analyzing part 211 may determine the thickness of an edge in a video after receiving each frame or scene of the input video. For example, a suitable edge operator such as a Sobel or Canny operator, may be used to calculate the thickness of an edge per pixel and subsequently to calculate an edge mask using a thresholding technique. A center line of the edge and a distance between a center of the edge and a boundary of the edge may be determined using a distance transformation technique. The distance between the center and boundary of the edge may correspond to the thickness of the edge. By plotting a histogram of all the edges in the input video, the thickest and strongest edge may be selected.

Once the thickness of the thickest edge is determined, the resolution determining part 213 may determine the resolution per the thickest edge using the technique described above (e.g., mapping charts). In some cases, an edge may appear to be stronger and thicker because the video is shot at a short distance between the camera and subject. Accordingly, the resolution may be lowered for such strong and thick edges and the resolution may be increased for thinner edge thicknesses. In general, a thickness threshold may be used to determine thick and thin edge thicknesses. For example, an edge thickness greater than the thickness threshold could be considered a thick edge thickness and an edge thickness lower than the thickness threshold could be considered a thin edge thickness. The resolution determining part 213 may be equipped with a mapping chart providing a relationship between a thickness of an edge and the resolution in a manner similar to FIG. 6 and FIG. 7. For example, instead of providing the distance between the camera and subject on the X-axis, the thickness of an edge may be provided.

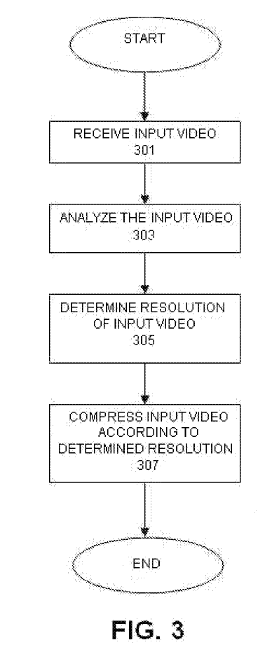

FIG. 3 is a flow chart illustrating a video analyzing method according to exemplary embodiments of the present invention. In particular, FIG. 3 may illustrate an operation of the video analyzing device 100.

As shown in FIG. 3, after the video analyzing device 100 receives the input video 301, the video analyzing device 100 may analyze the input video per frame or scene 303. The video analyzing device 100 may use various techniques to analyze the input video including the resolution determination techniques described above and explained in further detail below.

The video analyzing device 100 may then determine a resolution of the received input video 305 based on the video analysis result, and may compress the input video according to the determined resolution 307. The resolution may be determined in any suitable manner, including, for example, using mapping charts, as described above.

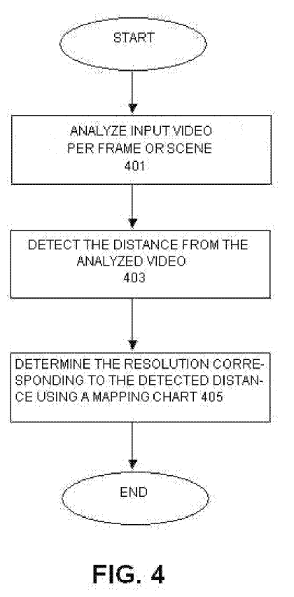

FIG. 4 is a flow chart illustrating the video analyzing method used in step 303 of FIG. 3. The method illustrated in FIG. 4 may correspond to a method of determining a resolution based on the distance between the camera and the subject, as noted above.

Referring to FIG. 4, at step 401, the video analyzing part 211 may analyze the input video per frame or scene. The video analyzing part 211 may then detect (step 403) the distance between the camera and the subject using any suitable method including, for example, methods for detecting a distance between the camera and the subject on a screen.

At step 405, the resolution determining part 213 may determine a resolution corresponding to the detected distance using the pre-determined mapping chart. The mapping chart can be similar to the mapping charts discussed with reference to FIG. 6 or FIG. 7. As explained above, a lower resolution may be determined for smaller distances, and a higher resolution may be determined for longer distances. For example, in some cases, a face shot whose distance may be determined to be at 50 cm, may be mapped to the SD class resolution, and, in some cases, a full-length shot whose distance may be determined to be 3 m or more, may be mapped to the HD class resolution.

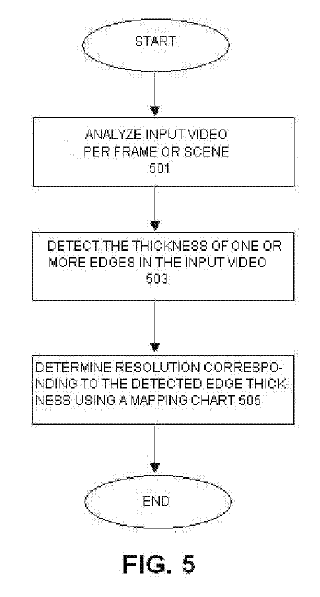

FIG. 5 is a flow chart illustrating the video analyzing method used in step 303, according to exemplary embodiments of the invention. In particular, FIG. 5 illustrates a method of determining a resolution based on a strongest and thickest edge of a video.

Referring to FIG. 5, the video analyzing part 211 may analyze (step 501) a received input video per frame or scene. Subsequently, the video analyzing part 211 may detect (step 503) the thickness of one or more edges in the input video using the methods described hereinabove.

The resolution determining part 213 may determine (step 505) the resolution per edge thickness using the pre-determined mapping chart as explained above. The mapping chart may determine a lower resolution to correspond to a stronger and thicker edge, and a higher resolution to correspond to a thinner edge.

The video analyzing method described herein according to exemplary embodiments of the present invention may provide a more efficient video compression technique by allocating different resolutions per frame or scene within a video. While exemplary embodiments provide video analyzing methods using a distance or edge thickness, it should be understood that other suitable methods may be used and that a resolution may be determined using any suitable criteria, including, for example, determining higher resolutions for frames having a caption and/or title.

Exemplary embodiments of the present invention provide an apparatus and method that can substantially improve the bit rate necessary for compressing videos by using efficient compression techniques, and can obtain relatively better video quality by compressing videos and adjusting the video resolution according to a required resolution.

It should be understood that exemplary embodiments of the invention may be executed in hardware, software, or any combination thereof. For example, any suitable computer processor and/or assembly/programming language (e.g., operating system) may be used to implement exemplary embodiments of the invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A video processing system, comprising:
an analyzing part to receive a video, to analyze the video per frame or scene, and to determine a resolution of the frame or scene; and
a compressing part to compress the video based on the resolution.

2. The video processing system of claim 1, wherein the analyzing part comprises:
a video analyzing part to estimate a distance between a camera and a subject obtained by the camera in at least one frame of the received video; and
a resolution determining part to determine the resolution, the resolution corresponding to the estimated distance in accordance with a mapping table.

3. The video processing system of claim 2, wherein the mapping table determines a lower resolution for a shorter distance between the camera and the subject, and a higher resolution for a longer distance between the camera and the subject, the longer distance being greater than a threshold, and the shorter distance being shorter than the threshold.

4. The video processing system of claim 1, wherein the analyzing part comprises:
a video analyzing part to detect an edge thickness in the video; and
a resolution determining part to determine the resolution, the resolution corresponding to the edge thickness in accordance with a mapping table.

5. The video processing system of claim 4, wherein the mapping table determines a lower resolution for a thick edge thickness, and a higher resolution for a thin edge thickness, the thick edge thickness being greater than a threshold, and the low edge thickness being thinner than the threshold.

6. A method to analyze a video, comprising:
receiving an input video;
analyzing the input video per frame or scene;
determining a resolution of the input video; and
compressing the input video based on the resolution.

7. The method of claim 6, wherein analyzing comprises estimating a distance between a camera and a subject obtained by the camera in at least one frame of the input video, and
wherein the resolution corresponds to the estimated distance in accordance with a mapping table.

8. The method of claim 7, wherein a lower resolution is determined if a shorter distance is estimated between the camera and the subject, and a higher resolution is determined if a longer distance is estimated between the camera and the subject, the longer distance being greater than a threshold, and the shorter distance being shorter than the threshold.

9. The method of claim 6, wherein analyzing comprises detecting an edge thickness in the received input video, and
wherein the resolution corresponds to the edge thickness in accordance with a mapping table.

10. The method of claim 9, wherein a lower resolution is determined if a thick edge thickness is estimated, and a higher resolution is determined if a thin edge thickness is estimated, the thick edge thickness being greater than a threshold, and the low edge thickness being thinner than the threshold.

11. A video processing system having a saving and recording media, the saving and recording media configured to:
analyze an input video per frame or scene;
determine a resolution of the input video; and
compress the input video based on the resolution.

12. The video processing system of claim 11, wherein analyzing comprises estimating a distance between a camera and a subject obtained by the camera in at least one frame of the input video, and
wherein the resolution corresponds to the estimated distance in accordance with a mapping table.

13. The video processing system of claim 12, wherein the saving and recording media comprises the mapping table, the mapping table being configured to determine a lower resolution for a shorter distance between the camera and the subject, and a higher resolution for a longer distance between the camera and the subject, the longer distance being greater than a threshold, and the shorter distance being shorter than the threshold.

14. The video processing system of claim 11, wherein analyzing comprises detecting an edge thickness of an edge in the received input video, and
wherein the resolution corresponds to the edge thickness in accordance with a mapping table.

15. The video processing system of claim 14, wherein the saving and recording media comprises the mapping table, the mapping table being configured to determine a lower resolution for a thick edge thickness, and a higher resolution for a thin edge thickness, the thick edge thickness being greater than a threshold, and the low edge thickness being thinner than the threshold.
